(19) United States
(12) Patent Application Publication
(10) Pub. No.: US 2026/0035284 A1
(43) Pub. Date: Feb. 5, 2026

(54) METHODS AND SYSTEMS FOR PRODUCING HOLLOW-CORE PREFORMS, COMPONENTS THEREOF, AND HOLLOW-CORE OPTICAL FIBERS

(71) Applicant: CORNING INCORPORATED, CORNING, NY (US)

(72) Inventors: David Alan Deneka, Corning, NY (US); Christopher Scott Thomas, Horseheads, NY (US)

(21) Appl. No.: 19/277,573

(22) Filed: Jul. 23, 2025

Related U.S. Application Data
(60) Provisional application No. 63/678,600, filed on Aug. 2, 2024.

(51) Int. Cl. C03B 37/022

(52) U.S. Cl. CPC C03B 37/022; C03B 2203/16

(57) ABSTRACT

Methods and systems for producing a hollow-core optical fiber preform and/or components thereof are described herein. In some embodiments, the method may include providing a precursor material, extruding the precursor material through a die assembly to a shaped body, and forming a hollow-core optical fiber preform or a component thereof from the shaped body. In some embodiments, providing the precursor material may include one of: heating the precursor material such that a viscosity of the precursor material reaches about 10³ to about 10⁷ poise, or forming a paste comprising a glass powder and a binder. In some embodiments, the hollow-core optical fiber preform may include an outer tube. In some embodiments, the hollow-core optical fiber preform may further include one of an inner tube coupled to the outer tube, or a spiral coupled to the outer tube.

This application claims the benefit of priority under 35 U.S.C. § 119 of U.S. Provisional Application Ser. No. 63/678,600 filed on Aug. 2, 2024, the content of which is relied upon and incorporated herein by reference in its entirety.

### FIELD

The present disclosure generally relates to methods and systems for producing optical fibers, and more specifically, to methods for producing hollow-core preforms for producing hollow-core optical fibers.

### BACKGROUND

Hollow-core optical fiber is an emerging product that is gaining attention due to its potentially low attenuation and very low latency. The internal microstructure of the hollow-core optical fiber is unique in that the light travels through the air in the fiber, bound by structural features or cladding elements in the fiber defining the hollow core. There are many varieties of the cladding elements, such as round capillaries, nested capillaries, spirals, etc. The microstructure of the hollow-core optical fiber, such as dimensions and/or locations of the cladding elements are important because it dictates how well light will travel down the fiber. Accordingly, there is a need to produce hollow-core optical fibers and hollow-core preforms for drawing the fiber with ease and precision.

### SUMMARY

Described herein include systems and methods for producing hollow-core preforms, including components thereof, via extrusion.

In some embodiments, a method of producing a hollow-core optical fiber preform and/or a component thereof may include providing a precursor material, extruding the precursor material through a die assembly to a shaped body, and forming a hollow-core optical fiber preform or a component thereof from the shaped body. In some embodiments, providing the precursor material may include one of: heating the precursor material such that a viscosity of the precursor material reaches about 10³ to about 10⁷ poise, or forming a paste comprising a glass powder and a binder, wherein the precursor material comprises the paste. In some embodiments, the hollow-core optical fiber preform may include an outer tube and one of: an inner tube, or a spiral panel. In some embodiments, an outer surface of the inner tube may contact an inner surface of the outer tube. In some embodiments, an outer surface of the spiral panel may contact an inner surface of the outer tube.

In some embodiments, a die assembly for making a hollow-core optical fiber preform or a component thereof via extrusion may include a first insert, a second insert, and a shell. The hollow-core preform or the component thereof may include an outer tube and an inner tube, and an outer surface of the inner tube may contact an inner surface of the outer tube. The firs insert may include a first plate having a plurality of first openings and a mandrel extending from the first plate. The second insert may include a second plate having a plurality of second openings, a column extending from the second plate, and a channel extending through the second plate and the column and configured for receiving therein the mandrel of the first insert while maintaining a first annular gap around the mandrel of the first insert. The shell may be configured for receiving therein the first insert and the second insert and having a first cavity portion and a second cavity portion. The second cavity portion may include a diameter less than a diameter of the first cavity portion. The second cavity portion may be configured to receive therein at least a portion of the column of the second insert whiling maintaining a second annular gap around the column. The first insert, the second insert, and the shell may be configured such that when the die assembly is in an assembled state and in use, a first material portion extruded from the first annular gap and a second material portion extruded from the second annular gap may be coupled upon extrusion from the die assembly.

In some embodiments, a die assembly for making a hollow-core optical fiber preform or a component thereof via extrusion may include a shell, a first insert, and a second insert. The hollow-core preform or the component thereof may include an outer tube and an inner tube, and an outer surface of the inner tube may contact an inner surface of the outer tube. The shell may include a first wall portion and a second wall portion arranged along an axial direction of the die assembly. The first wall portion may include an inner surface defining a first cavity portion that may be cylindrical and have a first diameter. The second wall portion may include a first inner surface extending radially inward from the inner surface of the first wall portion, a second inner surface that may be tapered and define a second cavity portion having a frustum shape; and a third inner surface defining a third cavity portion that may be cylindrical and have a third diameter less than the first diameter of the first cavity portion of the first wall portion. The second inner surface may be disposed between the first inner surface and the second inner surface. The first insert may include a first plate having a first surface and a second surface opposite the first surface and defining a plurality of first openings extending through the first plate from the first surface to the second surface along the axial direction. The first insert may further include a mandrel extending from the second surface of the first plate along the axial direction. The second insert may include a second plate having a first surface and a second surface opposite the first surface and defining a plurality of second openings extending through the second plate from the first surface to the second surface along the axial direction. The second insert may further include a column extending from the second surface of the second plate along the axial direction, and a channel extending through the second plate and the column and configured for receiving therein the mandrel of the first insert while maintaining a first annular gap between the mandrel of the first insert and the column and the second plate of the second insert. The first insert and the second insert may be configured to be received inside the shell such that when the die assembly is in an assembled state, the second insert may be supported by the first inner surface of the second wall portion of the shell, the first insert may be supported by the first surface of the second plate of the second insert, the second surface of the first plate of the first insert and the first surface of the second plate of the second insert may be spaced apart along the axial direction by a plurality of spacers, and at least a portion of the column of the second insert may be received in the third cavity portion of the second wall portion of the shell. A diameter of the column of the second insert may be less than the third diameter of the third cavity portion such that a second annular gap may be maintained between the column of the second insert and the second wall portion of the shell. The shell, the first insert, and the second insert may be configured such that a first material portion extruded from the first annular gap and a second material portion extruded from the second annular gap may be coupled upon extrusion from the die assembly.

A die assembly for making a hollow-core optical fiber preform or a component thereof via extrusion may include an insert and a shell for receiving therein the insert. The hollow-core preform or the component thereof may include an outer tube and a spiral panel, and an outer surface of the spiral panel may contact an inner surface of the outer tube. The insert may include a plate having a plurality of openings forming portions of a tubular volume and a spiral member having a pair of spiral walls extending from the plate. The pair of spiral walls and the plate may collectively define a spiral channel extending through the plate and between the pair of spiral walls. The insert and the shell may be configured such that when the die assembly is in an assembled state and in use, material portions extruded through the plurality of openings may become fluidly coupled to each other to form a continuous tubular body, and a material portion extruded from the spiral channel may be fluidly coupled to the continuous tubular body upon extrusion from the die assembly.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIGS. 1A and 1B schematically illustrates examples of hollow-core optical fibers.

FIG. 2 schematically illustrates another example of a hollow-core optical fiber.

FIGS. 3A and 3B schematically illustrate examples of hollow-core preforms that may be utilized for producing the hollow-core optical fibers shown in FIGS. 1A and 1B, respectively.

FIG. 4 schematically illustrates an example of a hollow-core preform that may be utilized for producing the hollow-core optical fiber shown in FIG. 2.

FIG. 5 schematically illustrates an extrusion system that may be used for hot glass or polymer extrusion.

FIGS. 6A-6F schematically illustrates examples of shaped bodies that may be used as hollow-core preforms or components thereof for making hollow-core preforms and/or hollow-core optical fibers.

FIG. 7A schematically illustrates an exploded perspective view of an exemplary die assembly that may be used for extrusion of a hollow-core preform and/or components thereof.

FIG. 7B schematically illustrates a cross-sectional view of the die assembly of FIG. 7A in an assembled state.

FIG. 7C schematically illustrates a perspective view of an exemplary die insert.

FIG. 7D schematically illustrates a cross-sectional view of the exemplary die insert of FIG. 7C.

FIG. 7E schematically illustrates a bottom view of another exemplary die insert.

FIG. 7F schematically illustrates an exploded perspective view of another exemplary die assembly.

FIG. 7G schematically illustrates a cross-sectional view of the die assembly of FIG. 7F in an assembled state.

FIG. 7H schematically illustrates an exploded perspective view of another exemplary die assembly.

FIG. 7I schematically illustrates a cross-sectional view of the die assembly of FIG. 7H in an assembled state.

FIG. 7J schematically illustrates perspective view of another exemplary die insert.

FIG. 7K schematically illustrates a perspective view of another exemplary die insert.

FIG. 8A schematically illustrates an exploded perspective view of another exemplary die assembly that may be used for extrusion of a hollow-core preform and/or components thereof.

FIG. 8B schematically illustrates a cross-sectional view of the die assembly of FIG. 8A in an assembled state.

FIG. 9A schematically illustrates an exploded perspective view of another exemplary die assembly that may be used for extrusion of a hollow-core preform and/or components thereof.

FIG. 9B schematically illustrates a bottom perspective view of the die insert of the die assembly of FIG. 9A.

FIG. 9C schematically illustrates a cross-sectional view of the die assembly of FIG. 9A in an assembled state.

FIG. 9D schematically illustrates an exploded perspective view of another exemplary die assembly that may be used for extrusion of a hollow-core preform and/or components thereof.

FIG. 9E schematically illustrates a bottom view of the die insert of the insert of FIG. 9D.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, “greater than or equal to” and “≥” are used interchangeably, “less than or equal to” and “≤” are used interchangeably, “greater than” and “>” are used interchangeably, and “less than” and “<” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

Directional terms as used herein-for example up, down, right, left, front, back, top, bottom-are made only with reference to the figures as drawn and are not intended to imply absolute orientation.

Various components described herein may be referred to as “directly connected” or “indirectly connected.” Components are directly connected when they are joined to one another with no intervening structure. Components may be joined by fusing, melting, welding, soldering, adhesives, or any other suitable attachment means. Components are “indirectly connected” when they are joined to one another with intervening structure. Examples of intervening structure include welding aids (e.g., frits, solders, fluxes), adhesives, and bonding materials. In some embodiments, components connected indirectly are connected only by a welding aid, adhesive, or bonding material. The term “connected” means “directly connected” or “indirectly connected.” Components “directly connected” to one another are said to be in direct contact with each other. Components “indirectly connected” to one another are said to be in indirect contact with each other. Components “connected” to one another are in direct or indirect contact with each other.

As used herein, the terms “upstream” and “downstream” refer to the relative positioning of unit operations with respect to the direction of flow of the process streams. A first unit operation of a system may be considered “upstream” of a second unit operation if process streams flowing through the system encounter the first unit operation before encountering the second unit operation. Likewise, a second unit operation may be considered “downstream” of the first unit operation if the process streams flowing through the system encounter the first unit operation before encountering the second unit operation.

As used herein, the term “linear” refers to relative distances/lengths between points. A “linear” distance/length may refer to a distance between two points along a straight line.

As used herein, the singular forms “a,” “an” and “the” include plural referents in addition to the single referent unless the context clearly dictates otherwise. Thus, for example, reference to “a” component includes aspects having one such component as well as two or more such components, unless the context clearly indicates otherwise.

Reference will now be made in detail to various embodiments. Whenever possible, the same reference numerals will be used throughout the drawings to refer to the same or like parts.

### Hollow-Core Optical Fiber

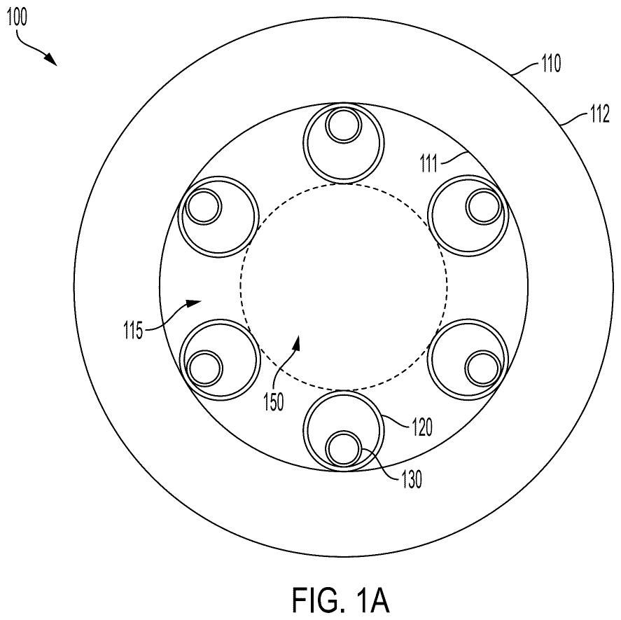

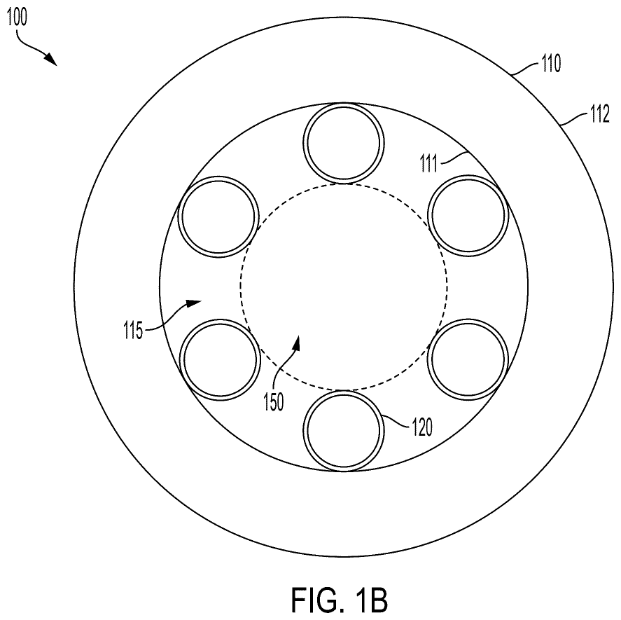

FIG. 1A schematically illustrates an example of a hollow-core optical fiber 100. The hollow-core optical fiber 100 may include an outer cladding 110. The outer cladding 110 may include an inner surface 111 defining an interior cavity 115 and an outer surface 112. The hollow-core optical fiber 100 may further include two or more (e.g., two, three, four, five, six, or more) cladding elements, such as capillaries 120, inside the interior cavity 115 of the outer cladding 110. The capillaries 120 may be in contact with and/or attached to the inner surface 111 of the outer cladding 110. The capillaries 120 may not be in contact with each other and may be evenly spaced along the inner surface 111 of the outer cladding 110. In some embodiments, the cladding elements of the hollow-core optical fiber 100 may also include nested capillaries 130 with each disposed inside a capillary 120 and in contact with and/or attached to an inner surface of the capillary 120. In some embodiments, the hollow-core optical fiber 100 may not include nested capillaries 130, such as shown in FIG. 1B. The cladding elements of the hollow-core optical fiber 100, e.g., the capillaries 120 and/or the nested capillaries 130, may surround and define a hollow core 140 of the hollow-core optical fiber 100. The hollow core 140 may be the central portion of the interior cavity 115 and may correspond to the region of the hollow-core optical fiber 100 in which optical signals may be primarily confined and propagate. In some embodiments, the outer cladding 110, the capillaries 120, and/or the nested capillaries 130 may include silica glass and/or silica-based glass (i.e., silica glass comprising one or more dopants). In some embodiments, the outer cladding 110, the capillaries 120, and/or the nested capillaries 130 may include a polymer.

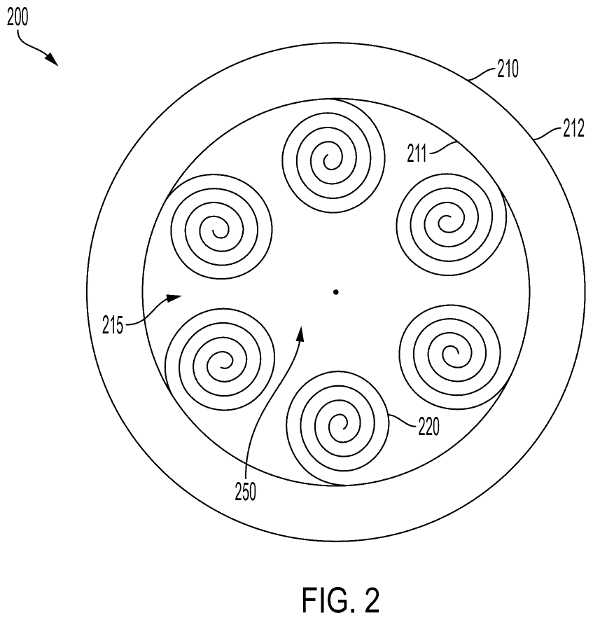

FIG. 2 schematically illustrates another exemplary of a hollow-core optical fiber 200. The hollow-core optical fiber 200 may include an outer cladding 210. The outer cladding 210 may include an inner surface 211 defining an interior cavity 215 and an outer surface 212. The hollow-core optical fiber 200 may further include two or more (e.g., two, three, four, five, six, or more) cladding elements, such as spiral sheets 220, inside the interior cavity 215 of the outer cladding 210. The spiral sheets 220 may be in contact with and/or attached to the inner surface 211 of the outer cladding 210. The spiral sheets 220 may not be in contact with each other and may be evenly spaced along the inner surface 211 of the outer cladding 210. The cladding elements of the hollow-core optical fiber 200, e.g., the spiral sheets 220, may surround and define a hollow core 240 of the hollow-core optical fiber 200. The hollow core 240 may be the central portion of the interior cavity 215 and may correspond to the region of the hollow-core optical fiber 200 in which optical signals may be primarily confined and propagate. In some embodiments, the outer cladding 210 and/or the spiral sheets 220 may include silica glass and/or silica-based glass (i.e., silica glass comprising one or more dopants). In some embodiments, the outer cladding 210 and/or the spiral sheets 220 may include a polymer.

### Hollow-Core Preform

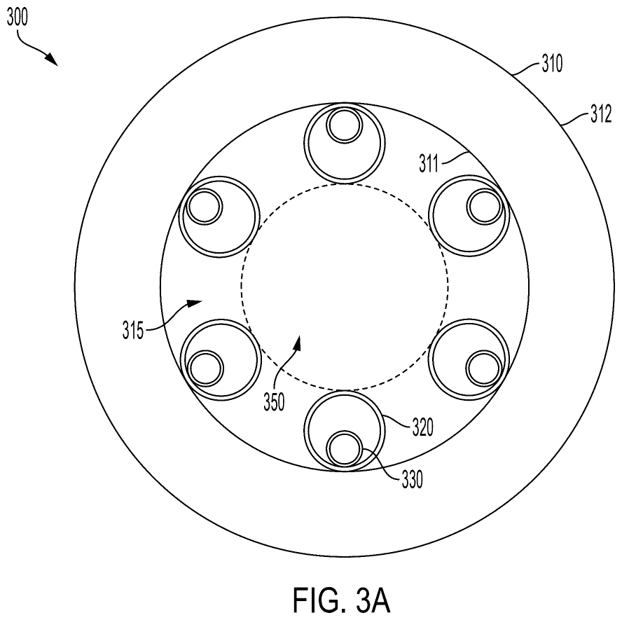

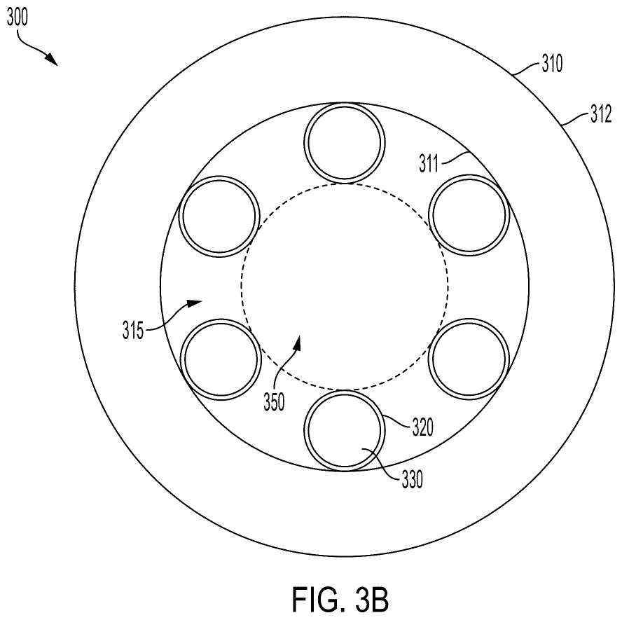

The hollow-core optical fiber 100, 200 may be produced by drawing a hollow-core preform into fiber. FIGS. 3A and 3B schematically illustrate non-limiting examples of hollow-core preforms 300 that may be utilized for producing the hollow-core optical fibers 100 shown in FIGS. 1A and 1B, respectively. In some embodiments, the hollow-core preform 300 may include an outer tube 310. The outer tube 310 may include an inner surface 311 defining an interior cavity 315 and an outer surface 312. In some embodiments, the hollow-core preform 300 may further include two or more (e.g., two, three, four, five, six, or more) inner tubes 320 inside the interior cavity 315 of the outer tube 310. In some embodiments, the inner tubes 320 may be in contact with and/or attached to the inner surface 311 of the outer tube 310. In some embodiments, the inner tubes 320 may not be in contact with each other and may be evenly spaced along the inner surface 311 of the outer tube 310. In some embodiments, such as shown in FIG. 3A, the hollow-core preform 300 may also include two or more nested tubes 330 with each disposed inside an inner tube 320 and in contact with and/or attached to an inner surface of the inner tube 320. In some embodiments, the hollow-core preform 300 may not include nested tubes 330, such as shown in FIG. 3B. The inner tubes 320 may surround and define a hollow section 340 that may be the central portion of the interior cavity 315 and correspond to the hollow core 140 of the hollow-core optical fiber 100 that may be drawn from the hollow-core preform 300. In some embodiments, the outer tube 310, the inner tubes 320, and/or the nested tubes 330 may include silica glass and/or silica-based glass (i.e., silica glass comprising one or more dopants). In some embodiments, the outer tube 310, the inner tubes 320, and/or the nested tubes 330 may include a polymer.

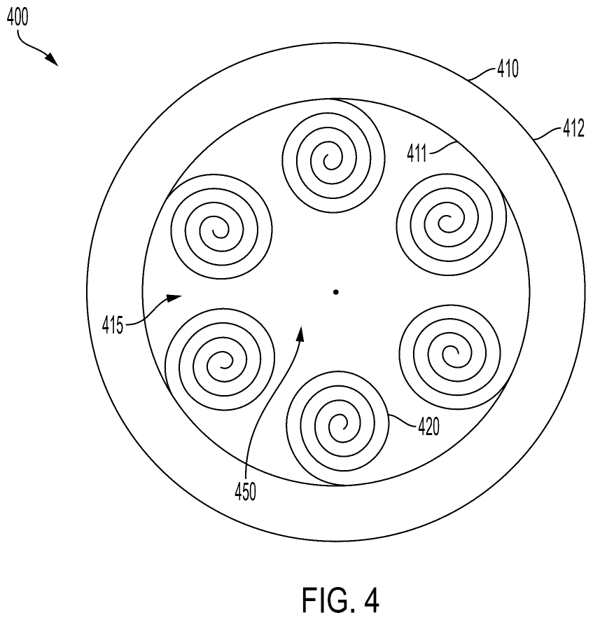

FIG. 4 schematically illustrates a non-limiting example of hollow-core preform 400 that may be utilized for producing the hollow-core optical fiber 200 shown in FIG. 2. In some embodiments, the hollow-core preform 400 may include an outer tube 410. The outer tube 410 may include an inner surface 411 defining an interior cavity 415 and an outer surface 412. In some embodiments, the hollow-core preform 400 may further include two or more (e.g., two, three, four, five, six, or more) spiral panels 420 inside the interior cavity 415 of the outer tube 410. In some embodiments, the spiral panels 420 may be in contact with and/or attached to the inner surface 411 of the outer tube 410. In some embodiments, the spiral panels 420 may not be in contact with each other and may be evenly spaced along the inner surface 411 of the outer tube 410. The spiral panels 420 may surround and define a hollow section 440 that may be the central portion of the interior cavity 415 and correspond to the hollow core 240 of the hollow-core optical fiber 200 that may be drawn from the hollow-core preform 400. In some embodiments, the outer tube 410 and/or the spiral panels 420 may include silica glass and/or silica-based glass (i.e., silica glass comprising one or more dopants). In some embodiments, the outer tube 410 and/or the spiral panels 420 may include a polymer.

### Producing Hollow-Core Preforms

One process for producing the hollow-core preform, e.g., preform 300 and/or preform 400, may include gathering smaller inner and/or nested tubes or spiral panels of appropriate sizes and/or aspect ratios and attaching the inner and/or nested tubes or spiral panels into a larger outer tube to form an intermediate assembly. The process may further include depositing soot on the exterior of the assembly, consolidating, and one or more redraws. Alternatively, in some embodiments, the intermediate assembly and/or even the entire preform may be produced via extrusion as discussed in more detail below.

### Hot Glass/Polymer Extrusion

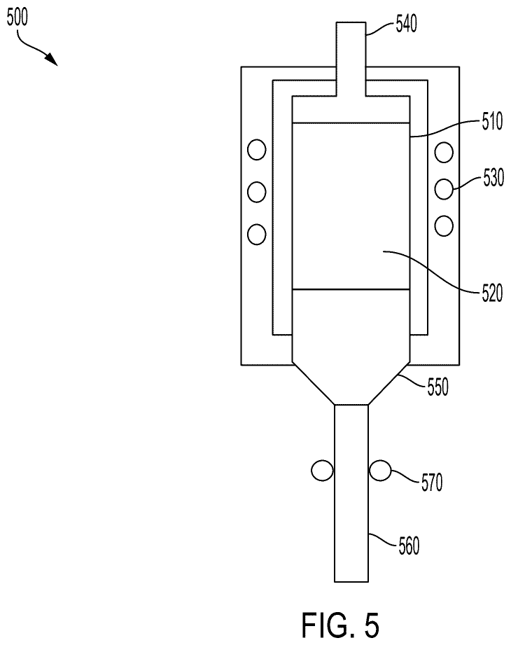

In some embodiments, the preform may be produced via hot glass extrusion. FIG. 5 schematically illustrates an extrusion system 500 that may be used for hot glass extrusion. The extrusion system 500 may include a barrel 510 configured for receiving a precursor material 520 and heating elements 530 positioned about the barrel 510 for heating the precursor material 520 until a viscosity of the precursor material 520 reaches about 103 to about 107 poise. The extrusion system 500 may also include a plunger 540 for pressing the heated precursor material 520 downward along the extrusion direction, thereby forcing the precursor material 520 out of a die assembly 550. The die assembly 550 may include features the precursor material 520 may flow around and take the intended form to form a shaped body 560. The extrusion system 500 may further include tractor wheels 570 or other pulling mechanism below the exit of the die assembly 550 configured for pulling the shaped body 560 downward away from the die assembly 550.

In some embodiments, the shaped body 560 may be in the shape of one of the components of a hollow-core preform, such as the outer tube, the inner or nested tube, or the spiral panel of the hollow-core preform, and the preform may be formed using one or more of these extruded components. In some embodiments, the shaped body 560 may be in the shape of a hollow-core preform, and the hollow-core preform may be formed by simply obtaining an appropriate length of the shaped body 560.

In some embodiments, the precursor material 520 may include a boule of glass. Depending on the range of the working temperature of the components of the extrusion system 500, appropriate glass may be selected for extrusion. For example, in some embodiments, stainless steel may be used for the barrel 510, the plunger 540, and/or the die assembly 550, which may result in an upper temperature limit of about 1000° C. for the viscosity range of the heated glass for extrusion. In some embodiments, other materials, e.g., titanium or alloys thereof, may be used for forming the components of the extrusion system 500 that may have higher working temperatures. The glass may also be chosen such that the glass may not easily devitrify at the extrusion temperatures. In some embodiments, the extrusion system 500 may be utilized for extruding glasses such as pure silica, doped silica, fused silica, quartz, etc. In some embodiments, the extrusion system 500 may be utilized for extruding glasses such as borosilicate glasses, aluminoborosilicate glasses, aluminosilicate glasses, fluorosilicate glasses, phosphosilicate glasses, fluorophosphate glasses, sulfophosphate glasses, germanate glasses, vanadate glasses, borate glasses, and/or phosphate glasses. Non-limiting examples of glasses may include Pyrex® or Vycor®.

In some embodiments, the precursor material 520 may include a polymer or polymers. Non-limiting examples of polymers may include acrylic, polyvinyl chloride (PVC), polyether ether ketone (PEEK), polyethylene, polypropylene, etc.

### Powered Glass Extrusion

In some embodiments, the preform may be produced via powdered glass extrusion. In some embodiments, a precursor material, such as a paste, for extrusion may be prepared by combing a glass powder with a binder. In some embodiments, the glass powder may include glass soot, such as doped or undoped silica soot. Other non-limiting exemplary glass powder may include powders of borosilicate glasses, aluminoborosilicate glasses, aluminosilicate glasses, fluorosilicate glasses, phosphosilicate glasses, fluorophosphate glasses, sulfophosphate glasses, germanate glasses, vanadate glasses, borate glasses, and/or phosphate glasses. In some embodiments, the binder may include methyl cellulose. Other non-limiting exemplary binder may include polyethylene, pine oil, polyvinyl alcohol, etc. In some embodiments, deionized water may be added to the precursor material or paste to achieve the proper viscosity for extrusion. The precursor material or paste may then be forced through a die assembly to form a shaped body. In some embodiments, the shaped body may be heat treated to burn out the binder. In some embodiments, the shaped body may be further exposed to a chlorine atmosphere to eliminate metallic and/or other contaminates. The shaped body may then be heat treated to sinter the glass powder, resulting in a clear glass body in some embodiments that may form the hollow-core preform or a component thereof.

Producing the hollow-core preform and/or the components thereof through extrusion, such as hot glass/polymer extrusion and/or powdered glass extrusion, may offer several advantages. For example, by extruding an internal structure inside a thickness of glass through hot glass extrusion or by extruding a body and sintering, one or more of the process steps, such as laydown, consolidating, and/or redraws may be reduced and/or eliminated, saving time during preform and/or fiber manufacturing. Additionally, structure stability may be improved as each of the eliminated process step has the potential for the inner and/or nested tubes or the spiral panels to shift and/or deform. Moreover, by eliminating the redraw steps, devitrification may be avoided. Further, via extrusion, the geometry of the preform may be set and taken directly to fiber drawing, and unique geometries may be formed that may not otherwise be easily made.

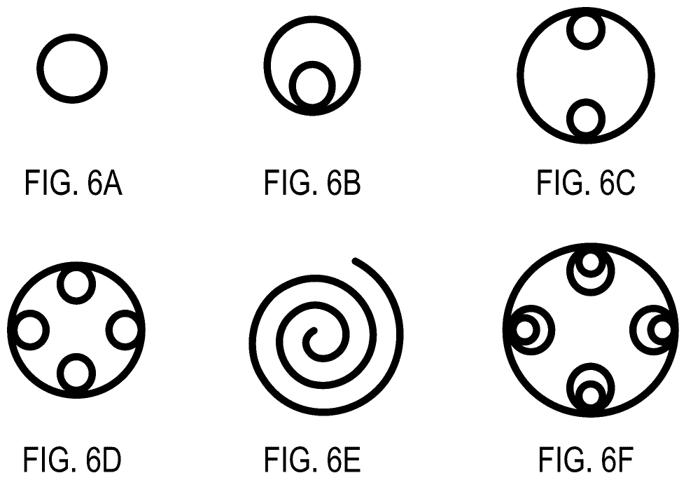

In addition to the hollow-core preforms 300, 400 and their respective components, e.g., the inner and/or nested tubes 320, 330, the spiral panels 420 described above, some non-limiting examples of preforms and/or components that may be produced via extrusion may further include a tube (such as shown in FIG. 6A), a tube with a single nested tube (such as shown in FIG. 6B), a tube with two or more nested tubes (such as shown in FIGS. 6C and 6D), a spiral (shown in FIG. 6E), a tube with one or more nested tubes each of which may further have one or more nested tubes (such as shown in FIG. 6F), etc. The structures shown in FIGS. 6A-6E and/or a combination thereof may be inserted into a sleeve having a greater diameter to form a hollow-core preform, or may be used as a preform directly.

### Exemplary Die Assemblies

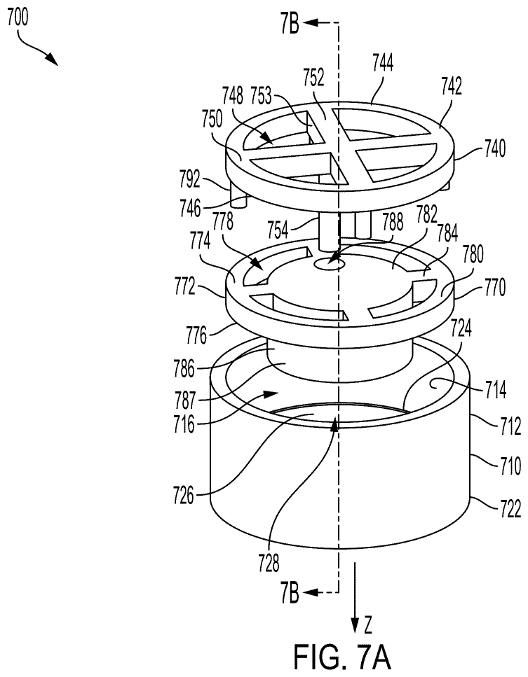

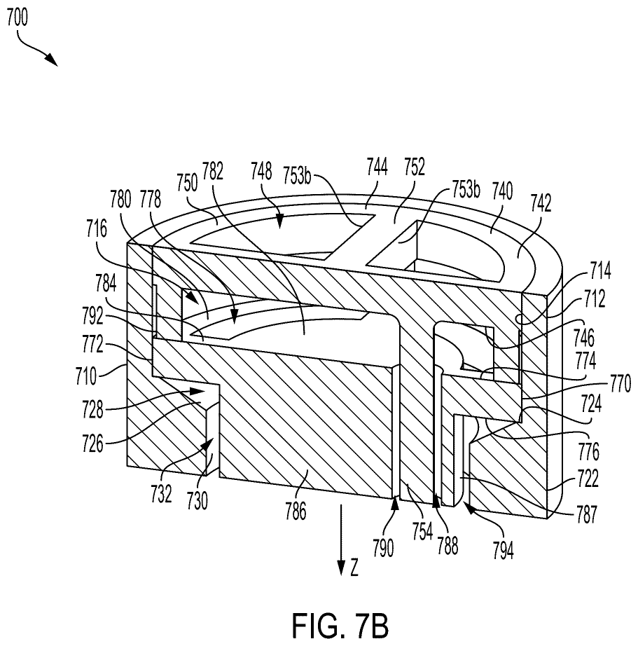

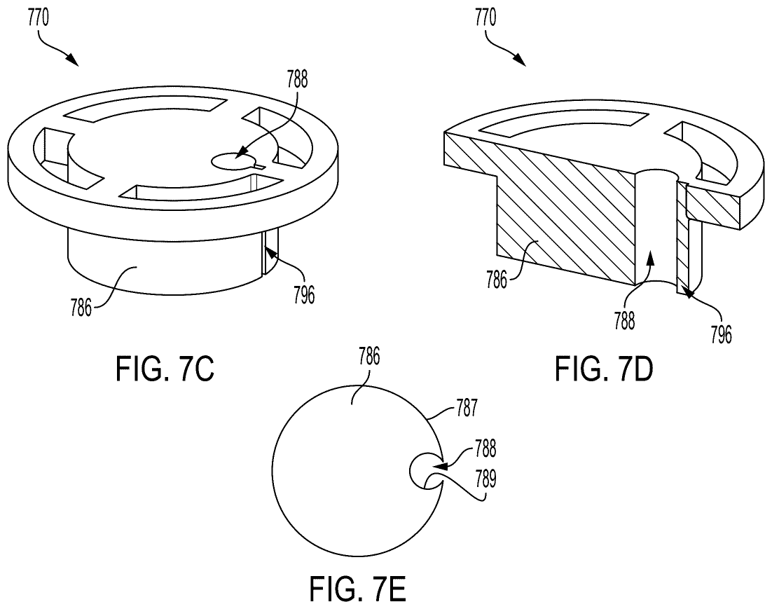

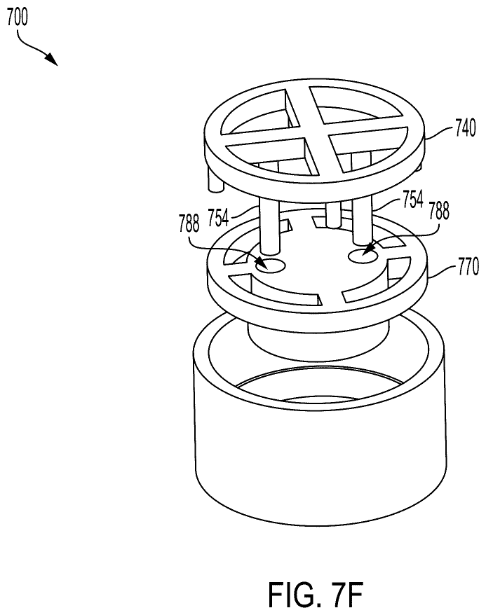

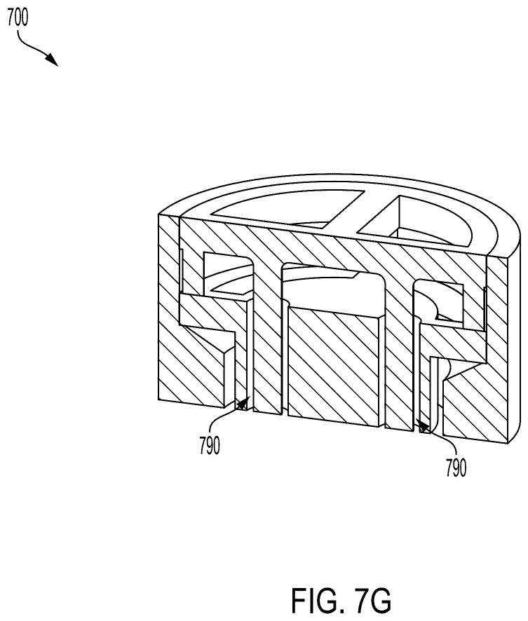

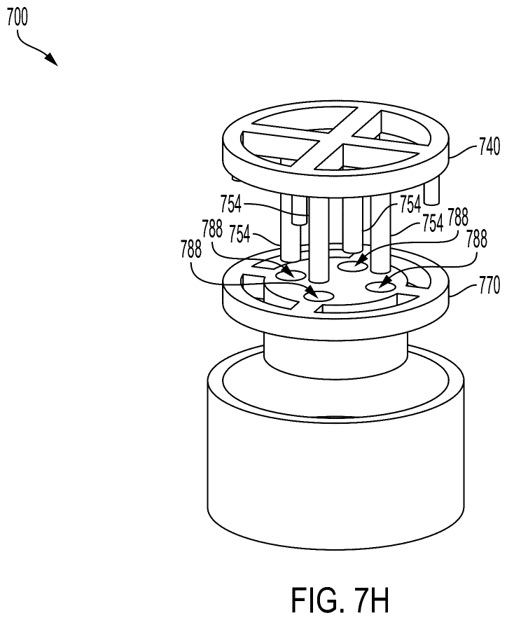

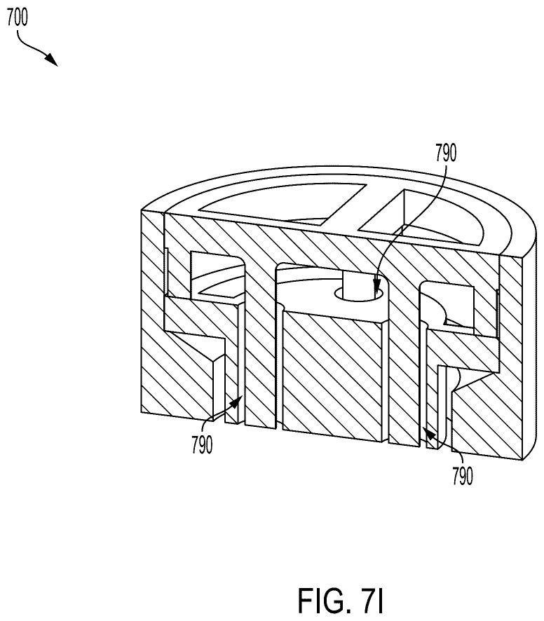

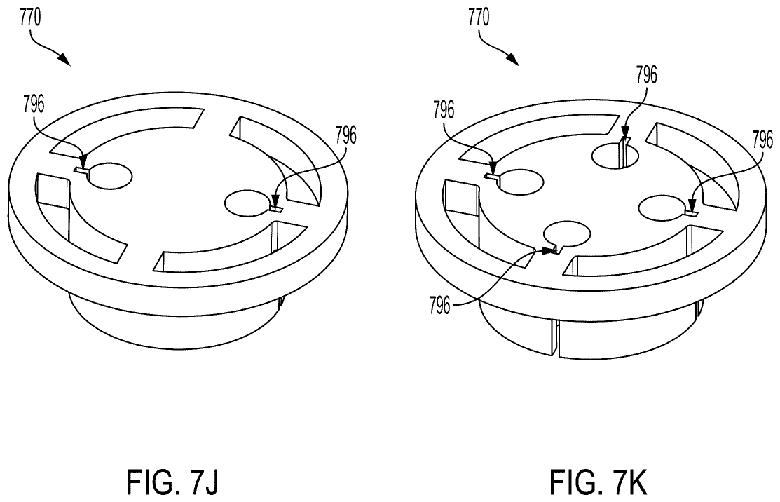

FIG. 7A illustrates an exploded perspective view of an exemplary die assembly 700 that may be used for the various extrusion processes described herein for producing a hollow-core preform and/or components thereof. FIG. 7B illustrates a cross-sectional view of the die assembly 700, viewed along line 7B-7B in FIG. 7A.

Referring to FIGS. 7A and 7B, the die assembly 700 may include a shell 710, a first insert 740, and a second insert 770. In some embodiments, the shell 710 may include a first wall portion 712 and a second wall portion 722 arranged along an axial direction (axis z in FIGS. 7A and 7B) of the die assembly 700. The axial direction may also correspond to the extrusion direction along which a precursor material may be fed into and extruded out of the die assembly 700. In some embodiments, the first wall portion 712 may include an inner surface 714 defining a first cavity portion 716. In some embodiments, the first cavity portion 716 may be cylindrical. In some embodiments, the second wall portion 722 may include a first inner surface 724 extending radially inward from the inner surface 714 of the first wall portion 712. In some embodiments, the second wall portion 722 may further include a second inner surface 726 extending from the first inner surface 724. The second inner surface 726 may be tapered and define a second cavity portion 728 having a frustum shape. In some embodiments, the second wall portion 722 may further include a third inner surface 730 extending from the second inner surface 726 defining a third cavity portion 732. The third cavity portion 732 may be cylindrical and may have a diameter less than a diameter of the first cavity portion 716 of the first wall portion 712.

In some embodiments, the first insert 740 may include a plate 742 having a first surface 744 and a second surface 746 opposite the first surface 744. The plate 742 may include one or more openings 748 extending through the plate 742 from the first surface 744 to the second surface 746 along the axial direction. The plate 742 may include a ring portion 750 and one or more legs 752 extending radially inward from an inner surface of the ring portion 750 transverse to the axial direction. The ring portion 750 and the one or more legs 752 may collectively define the one or more openings 748. The ring portion 7 may surround a cylindrical volume that may be divided by the one or more legs 752 into the openings 748. The openings 748 may thus form portions the cylindrical volume. In some embodiments, the first insert 740 may further include a mandrel 754 extending from the second surface 746 of the plate 742 along the axial direction. In some embodiments, the mandrel 754 may extend from the one or more legs 752.

In some embodiments, the second insert 770 may include a plate 772 having a first surface 774 and a second surface 776 opposite the first surface 774. The plate 772 may include one or more openings 778 extending through the plate 772 from the first surface 774 to the second surface 776 along the axial direction. In some embodiments, the plate 772 may include a peripheral portion 780 and a central portion 782. In some embodiments, the plate 772 may further include one or more bridges 784 extending radially (transverse to the axial direction) inward from an inner surface of the peripheral portion 780 to the central portion 782 and join the peripheral portion 780 to the central portion 782. In some embodiments, the peripheral portion 780, the central portion 782, and the one or more bridges 784 may collectively define the openings 778. In some embodiments, the peripheral portion 780 and the central portion 782 may define a tubular volume that may be divided by the one or more bridges 784 into the openings 778. The openings 778 may thus form portions of the tubular volume. The projection of the cylindrical volume defined by the ring portion 750 of the first insert 740 and the projection of the tubular volume defined by the peripheral portion 780 and the central portion 782 of the second insert 770 may overlap along the axial direction. The projections of the openings 748 of the first insert 740 along the axial direction may overlap with the projections of the openings 778 of the second insert 770.

In some embodiments, the second insert 770 may further include a column 786 extending from the second surface 776 of the plate 772 along the axial direction. In some embodiments, the column 786 may extend from the central portion 782 of the plate 772. In some embodiments, the second insert 770 may include a channel 788 extending through the plate 772 and the column 786. In some embodiments, the channel 788 may be disposed offset from the central axis of the second insert 770 and adjacent to a peripheral region of the column 786. In some embodiments, the channel 788 may be configured for receiving therein the mandrel 754 of the first insert 740 while maintaining an annular gap 790 between the mandrel 754 of the first insert 740 and the column 786 and the plate 772 of the second insert 770.

When the die assembly 700 is in an assembled state, such as shown in FIG. 7B, the first insert 740 and the second insert 770 may be received inside the shell 710. In some embodiments, the second insert 770 may be supported by the first inner surface 724 of the second wall portion 722 of the shell 710. In some embodiments, the first insert 740 may be supported by the first surface 774 of the plate 772 of the second insert 770. In some embodiments, the second surface 746 of the plate 742 of the first insert 740 and the first surface 774 of the plate 772 of the second insert 770 may be spaced apart along the axial direction by one or more spacers 792. In some embodiments, the spacers 792 may be formed as an integral part of the first insert 740 and may extend from the second surface 746 of the plate 742 of the first insert 740. In some embodiments, the spacers 792 may be formed as an integral part of the second insert and may extend from the first surface 774 of the plate 772 of the second insert 770.

When the die assembly 700 is in the assembled state, at least a portion of the column 786 of the second insert 770 may be received in the third cavity portion 732 of the shell 710. In some embodiments, a diameter of the column 786 of the second insert 770 may be configured to be less than the diameter of the third cavity portion 732 such that an annular gap 794 may be maintained between the column 786 of the second insert 770 and the second wall portion 722 of the shell 710.

The die assembly 700 may be used in an extrusion system, such as extrusion system 500 described above, for forming hollow-core preforms and/or components thereof. Referring to FIGS. 5, 7A, and 7B, during extrusion, the precursor material 520 may be forced to flow through the die assembly 700 to form the shaped body 560. Specifically, the precursor material 520 may flow through the openings 748 around the legs 752 of the plate 742 of the first insert 740. Due to the pressure applied from the plunger 540 and/or the viscosity of the precursor material 520, the precursor material 520 separated by the legs 752 of the first insert 740 may then combine and fill the space between the plate 742 of the first insert 740 and the plate 772 of the second insert 770 and surround the mandrel 754 before reaching the plate 772 of the second insert 770. In some embodiments, to further facilitate the combining of the precursor material 520 separated by the legs 752, the opposite side walls 753a, 753b of the legs 752 may be tapered or curved towards each other to guide the portions of the precursor material 520 on either side of the legs 752 to flow towards each other. Once combined, the precursor material 520 may then continue to flow through the openings 778 around the bridges 784 of the plate 772 of the second insert 770 into the space between the column 786 of the second insert 770 and the second wall portion 722 of the shell 710. The tapered second inner surface 726 of the second wall portion 722 of the shell 710 may facilitate the combining of the precursor material 520 separated by the bridges 784, and the combined precursor material 520 may continue to flow into the annular gap 794 between the third inner surface 730 of the second wall portion 722 of the shell 710 and the column 786 of the second insert 770. The precursor material 520 may also flow into the annular gap 790 between the mandrel 754 of the first insert 740 and the column 786 of the second insert 770.

The shell 710, the first insert 740, and the second insert 770 may be configured such that the portion of the precursor material 520 flowing through the annular gap 790 and the portion of the precursor material 520 flowing through the annular gap 794 may become coupled upon exiting the die assembly 700, forming a shaped body having a smaller tube nested inside a larger tube, similar to that shown in FIG. 6B.

To facilitate the coupling of the two portions of the precursor material 520 extruded through the annular gap 790 and the annular gap 794, in some embodiments, the channel 788 of the second insert 770 may be disposed radially close or adjacent to an outer surface 787 of the column 786 such that only a small separation may be present between the inner surface of the channel 788 and the outer surface 787 of the column 786. Thus, the portion of the precursor material 520 extruded from the annular gap 790 and the portion of the precursor material 520 extruded from the annular gap 794 may be coupled due to expansion of the material portions exiting the die assembly 700.

In some embodiments, to further facilitate the coupling of the two portions of the precursor material 520 extruded through the annular gap 790 and the annular gap 794, the second insert 770 may further include a slot 796, such as shown in FIGS. 7C and 7D. The slot 796 may extend along the axial direction and extend radially outward from the channel 788 such that the channel 788 may be in fluid communication with the exterior of the column 786 via the slot 796. Thus, the annular gap 790 and the annular gap 794 may be in fluid communication via the slot 796 when the die assembly 700 is in an assembled state, and the portion of the precursor material 520 in the annular gap 790 and the portion of the precursor material 520 in the annular gap 794 may be fluidly coupled to each other by the precursor material 520 prior to exiting the die assembly 700. It is noted that upon extrusion, the material portions of the precursor material 520 extruded from the annular gap 790 and the annular gap 794 may expand, and thus, the extruded form may not include the slot shape but just two tubular bodies joined together. In some embodiments, alternative to incorporating the slot 796, the channel 788 may be disposed further radially outward such that the inner surface 789 of the channel 788 may intercept the outer surface 787 of the column 786 (such as shown in FIG. 7E which illustrates a bottom view of the bottom portion of the column 786 and the channel 788), allowing for fluid communication between the channel 788 and the column 786 and fluid coupling between the portions of the precursor material 520 in the annual gap 790 and the annual gap 794 during extrusion.

While FIGS. 7A-7E illustrate an exemplary die assembly 700 for extruding a shaped body having a sleeve with one nested tube inside the sleeve, in some embodiments, the die assembly 700 may be configured for extruding shaped bodies having a sleeve with two or more tubes nested inside the sleeve, such as the shaped bodies shown in FIGS. 6C and 6D. In some embodiments, the first insert 740 may include more than one mandrel 754, such as two mandrels 754 (shown in FIGS. 7F and 7G), three mandrels 754, four mandrels (shown in FIGS. 7H and 7I), five mandrels 754, six mandrels 754, or any suitable number of mandrels 754. In some embodiments, the second insert 770 may include corresponding number of channels 788, such as two channels 788 (shown in FIGS. 7F and 7G), three channels 788, four channels 788 (shown in FIGS. 7H and 7I), five channels 788, six channels 788, or any suitable number of channels 788. Thus, more than one annular gap 790, such as two annular gaps 790 (shown in FIGS. 7F and 7G), three annular gaps 790, four annular gaps 790 (shown in FIGS. 7H and 7I), five annular gaps 790, six annular gaps 790, or any suitable number of annular gaps 790 may be formed for extruding the nested tubes. In some embodiments, the second insert 770 may further include corresponding number of slots 796 extending radially outward from the channels 788 to facilitate the combining of the nested tubes and the sleeve upon extrusion (such as shown in FIGS. 7J and 7K).

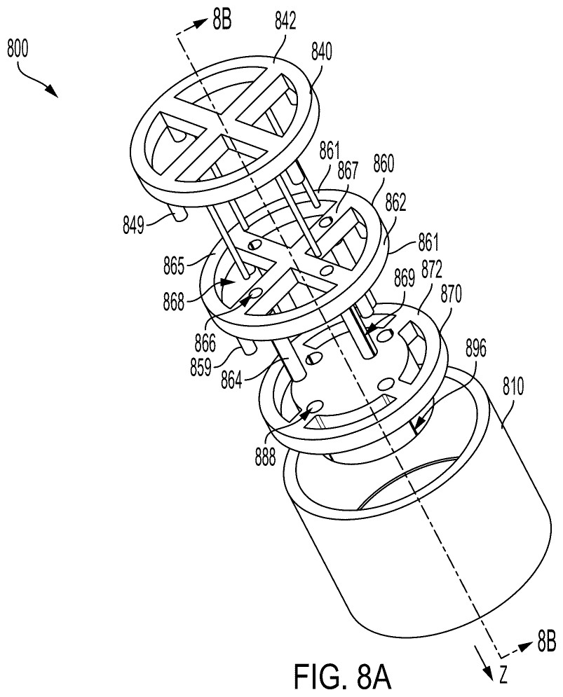

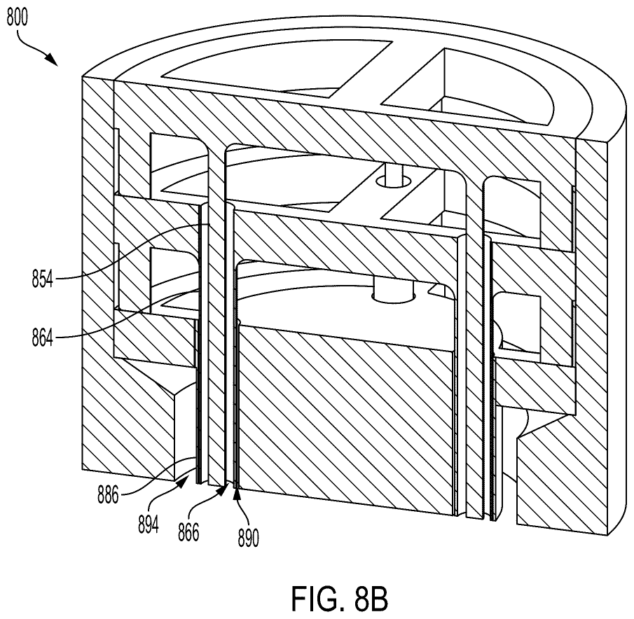

FIG. 8A illustrates an exploded perspective view of another exemplary die assembly 800 that may be used for the various extrusion processes described herein for producing a hollow-core preform and/or components thereof. FIG. 8B illustrates a cross-sectional view of the die assembly 800, viewed along line 8B-8B in FIG. 8A. The die assembly 800 may be similar to the die assembly 700 described in many aspects, and thus, similar reference numerals are used except that 800 series reference numerals are used instead of 700 series.

Similar to the die assembly 700, the die assembly 800 may include a shell 810, a first insert 840, and a second insert 870. The shell 810, the first insert 840, and the second insert 870 may be similar to or the same as the various examples of the shell 710, the first insert 740, and the second insert 770 of the die assembly 700 described above with reference to FIGS. 7A-7K, the description of which applicable to the shell 810, the first insert 840, and the second insert 870 is thus not repeated. However, the dimensions and/or disposition of parts/portions of the first insert 840, the second insert 870, and the shell 810 may be adjusted or modified to accommodate a third insert 860 (described below) disposed between the first insert 840 and the second insert 870 when the die assembly 800 is in an assembled state.

In some embodiments, the third insert 860 may include a plate 862 having a first surface 861 and a second surface 863 opposite the first surface 861. In some embodiments, the plate 862 of the third insert 860 may be spaced apart from the plate 842 of the first insert 840 by one or more spacers 849, and the plate 862 of the third insert 860 may also be spaced apart from the plate 872 of the second insert 870 by one or more spacers 859. In some embodiments, the plate 862 may include one or more openings 868 extending through the plate 862 from the first surface 861 to the second surface 863 along the axial direction. The plate 862 may include a ring portion 865 and one or more legs 867 extending radially inward from an inner surface of the ring portion 865 transverse to the axial direction. The ring portion 865 and the one or more legs 867 may collectively define the one or more openings 868. The ring portion 865 may surround a cylindrical volume that may be divided by the one or more legs 867 into the openings 868. The openings 868 may thus form portions the cylindrical volume. In some embodiments, the third insert 860 may further include one or more sleeves 864 extending from the second surface 863 of the plate 862 along the axial direction. In some embodiments, the sleeves 864 may extend from the one or more legs 867.

In some embodiments, the sleeves 864 may be configured to be received inside the channels 888 of the second insert 870 while an annular gap 890 may be maintained around each sleeve 864 such that the precursor material may be extruded through the annular gap 890. In some embodiments, the sleeves 864 may be further configured to receive therein the mandrels 854 of the first insert 840 while an annular gap 866 may be maintained between each of the sleeves 864 and the mandrel 854 received therein such than the precursor material may be extruded through the annular gap 866. In some embodiments, the sleeves 864 may each include a side opening 869. In some embodiments, the side opening 869 may be aligned with the slot 896 formed in the second insert 870, which may facilitate fluid coupling of the precursor material flowing in the annular gap 866 around the mandrels 854 of the first insert 840 to the precursor material flowing in the annular gap 890 around the sleeve 864 of the third insert 860 and further to the precursor material flowing in the annular gap 894 around the column 986 of the second insert 870. The die assembly 800 may be utilized form a shaped body similar to that shown in FIGS. 6F.

While the die assembly 800 illustrated in FIGS. 8A and 8B includes four mandrels 854, four sleeves 864, and four channel 888, any number (such as one, two, three, four, five, six, seven, eight, etc.) of cooperating mandrels 854, sleeves 864, and channel 888 may be implemented for the die assembly 800. Further, although the die assembly 800 includes only one intermediate insert, i.e., the third insert 860, between the first insert 840 and the second insert 870, any number of intermediate inserts may be implemented, with each intermediate insert including a sleeve that may be configured for receiving the sleeve(s) of other upstream intermediate insert(s) and the mandrel 854 of the first insert 840 and that may also be configured to be received in the sleeve(s) of other downstream intermediate insert(s) and the channel 888 of the second insert 870 for extruding tubes with any levels of nesting.

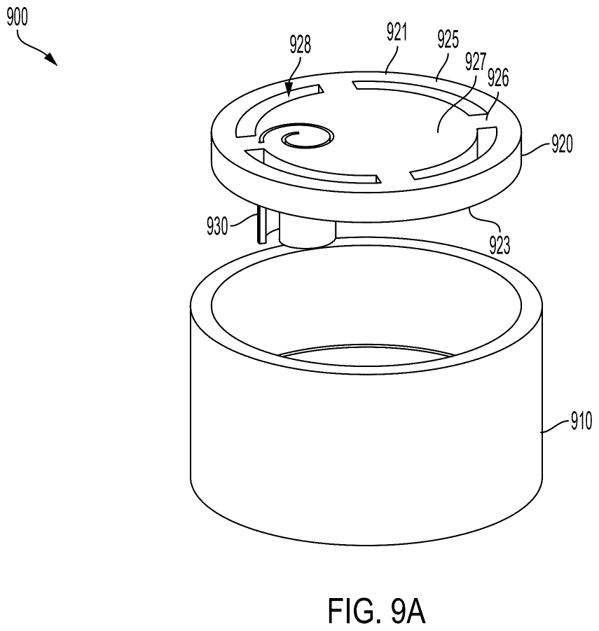

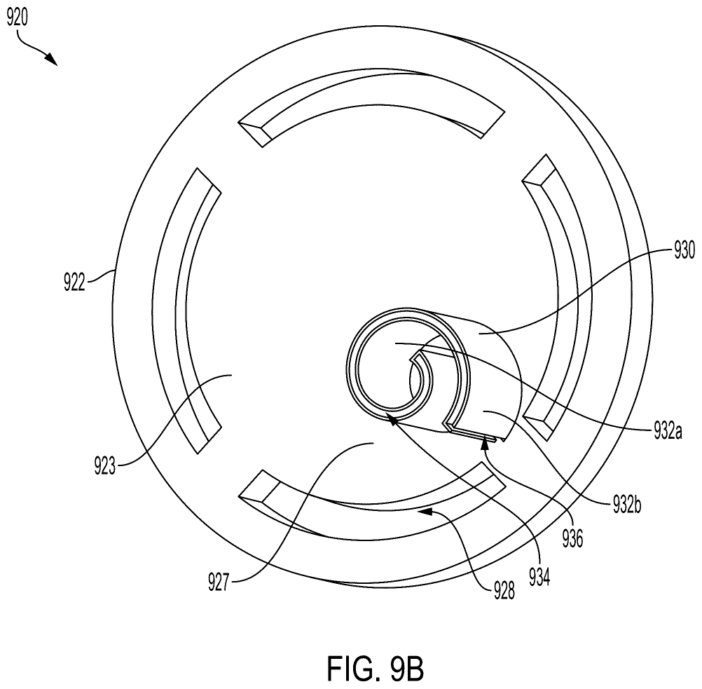

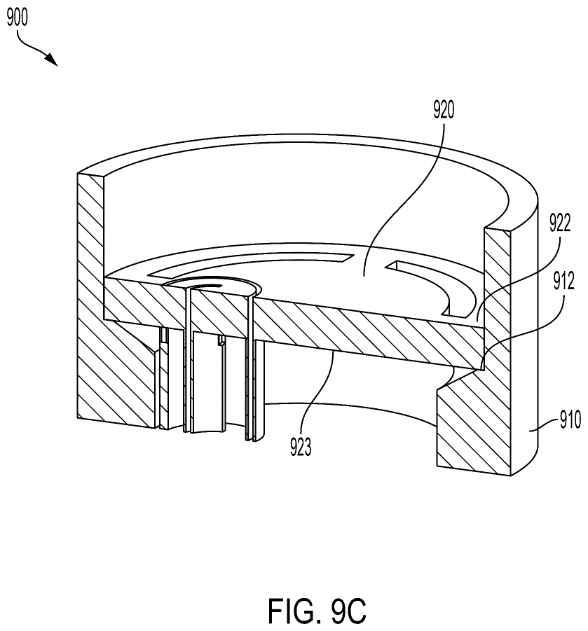

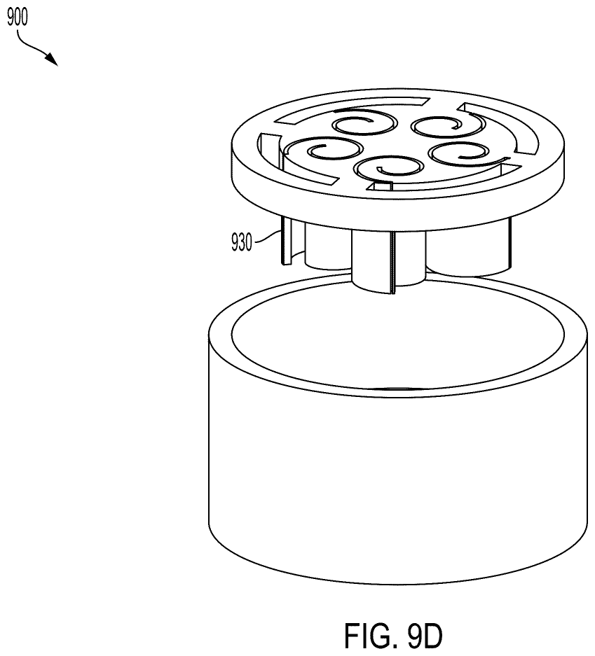

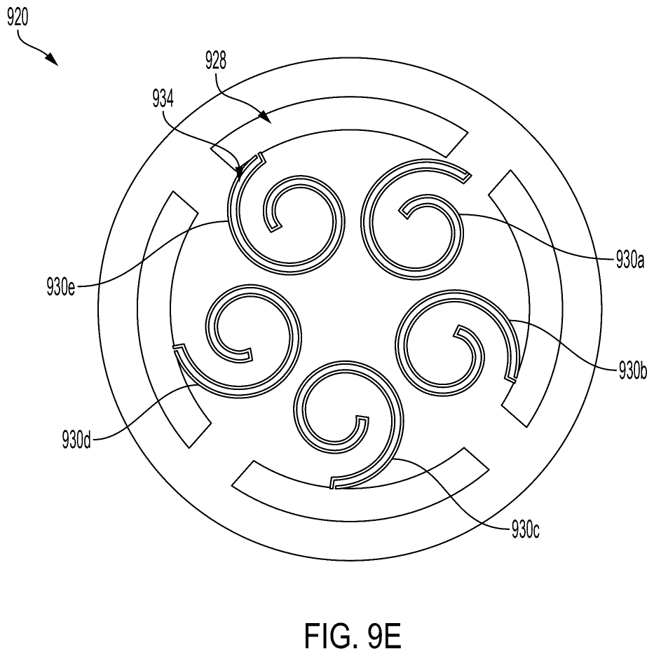

FIG. 9A illustrates an exploded perspective view of another exemplary die assembly 900 that may be used for the various extrusion processes described herein for producing a hollow-core preform and/or components thereof. The die assembly 900 may be similar to the die assemblies 700, 800 described in many aspects, and thus, similar reference numerals are used except that 900 series reference numerals are used instead of 700 and 800 series. In some embodiments, the die assembly 900 may include a shell 910 and an insert 920. In some embodiments, the shell 910 may be the same as or similar to the shell 710 of the die assembly 700 and the shell 810 of the die assembly 800 described above, the description of which applicable to the shell 910 is thus not repeated.

Referring to FIG. 9B which shows a bottom perspective view of the insert 920, in some embodiments, the insert 920 may include a plate 922 having a first surface 921 and a second surface 923 opposite the first surface 921. When the die assembly 900 is in the assembled state, the insert 920, more particularly, the plate 922 of the insert 920, may be supported by a radially extending inner surface 912 of the shell 910 contacting a peripheral region of the second surface 923 of the plate 922, such as shown in FIG. 9C which illustrates a cross-sectional view of the die assembly 900 in the assembled state. The plate 922 may include one or more openings 928 extending through the plate 922 from the first surface 921 to the second surface 923 along the axial direction. In some embodiments, the plate 922 may include a peripheral portion 925 and a central portion 927. In some embodiments, the plate 922 may further include one or more bridges 926 extending radially (transverse to the axial direction) inward from an inner surface of the peripheral portion 925 to the central portion 927 and join the peripheral portion 925 to the central portion 927. In some embodiments, the peripheral portion 925, the central portion 927, and the one or more bridges 926 may collectively define the openings 928. In some embodiments, the peripheral portion 925 and the central portion 927 may define a tubular volume that may be divided by the one or more bridges 926 into the openings 928. The openings 928 may thus form portions of the tubular volume.

Referring to FIG. 9B, in some embodiments, the insert 920 may further include a spiral member 930 extending from the second surface 923 of the plate 922 along the axial direction. In some embodiments, the spiral member 930 may extend from the central portion 927 of the plate 922. In some embodiments, the spiral member 930 may be disposed offset from the central axis of the insert 920 and adjacent to a peripheral region of the central portion 927 of the insert 920. In some embodiments, the spiral member 930 may include a pair of spiral walls 932a, 932b. In some embodiments, the pair of spiral walls 932a, 932b and the plate 922 may collectively define a spiral channel 934 that may extend through the plate 922 and between the pair of spiral walls 932a, 932b. The spiral wall 932a disposed inward relative to the spiral channel 934 with respect to the axis of the spiral member 930 may be referred to as the inner spiral wall 932a, and the spiral wall 932b disposed outward relative to the spiral channel 934 with respect to the axis of the spiral member 930 may be referred to as the outer spiral wall 932b.

When the die assembly 900 is in an assembled state and in use, portions of the precursor material extruded through the openings 928 may become fluidly coupled to each other to form a continuous tubular body. A portion of the precursor material may be extruded from the spiral channel 934 to form a spiral body and may be fluidly coupled to the continuous tubular body upon extrusion from the die assembly 900 to form a shaped body with a spiral coupled to an inner surface of a tube. In some embodiments, to facilitate the coupling between the tubular body and the spiral body, the spiral member 930 may further include a slot 936 formed in the outer spiral wall 932b. The slot 936 may extend axially throughout the entire length of the spiral member 930 and may extend radially outward from the spiral channel 934 to allow for fluid coupling between the spiral body extruded through the spiral channel 934 and the tubular body extruded outside the spiral channel 934.

While the die assembly 900 may be used for extruding a shaped body having a tube and one spiral member attached to the tube, in some embodiments, the insert 920 of the die assembly 900 may include two or more spiral members 930, such as two, three, four, five (such as shown in FIG. 9D), six, or any suitable number of spiral members 930 for extruding a shape body having a tube with any number of spiral members attached thereto. In some embodiments, depending on the location of spiral members 930, one or more of the spiral members 930 (such as spiral members 930b, 930c, 930d, 930e in FIG. 9E which illustrates a bottom plan view of the insert 920) may be in fluid communication with at least one of the openings 928 of the insert 920 to allow for fluid coupling of material portions extruded through the spiral channels 934 and the openings 928 of the insert 920.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A die assembly for making a hollow-core optical fiber preform or a component thereof via extrusion, wherein the hollow-core preform or the component thereof comprises an outer tube and an inner tube, wherein an outer surface of the inner tube contacts an inner surface of the outer tube, the die assembly comprising:
a first insert comprising a first plate having a plurality of first openings and a mandrel extending from the first plate;
a second insert comprising a second plate having a plurality of second openings, a column extending from the second plate, and a channel extending through the second plate and the column and configured for receiving therein the mandrel of the first insert while maintaining a first annular gap around the mandrel of the first insert; and
a shell configured for receiving therein the first insert and the second insert and having a first cavity portion and a second cavity portion, wherein the second cavity portion includes a diameter less than a diameter of the first cavity portion, and wherein the second cavity portion is configured to receive therein at least a portion of the column of the second insert whiling maintaining a second annular gap around the column;
wherein the first insert, the second insert, and the shell are configured such that when the die assembly is in an assembled state and in use, a first material portion extruded from the first annular gap and a second material portion extruded from the second annular gap are coupled upon extrusion from the die assembly.

2. The die assembly of claim 1, the channel of the second insert is disposed radially adjacent to an outer surface of the column of the second insert such that the first material portion extruded from the first annular gap and the second material portion extruded from the second annular gap are coupled upon extrusion from the die assembly due to expansion.

3. The die assembly of claim 1, wherein the second insert further comprises a slot extending along the axial direction throughout an entire length of the channel and extending radially outward from the channel such that the first annular gap is in fluid communication with the second annular gap via the slot.

4. The die assembly of claim 1, wherein:
the first insert further comprises:
a plurality of mandrels, each of the plurality of mandrels extending from the second surface of the first plate along the axial direction; and
the second insert further comprises:
a plurality of channels, each of the plurality of channels extending through the second plate and the column of the second insert, each of the plurality of channels configured for receiving therein one of the plurality of mandrels of the first insert while maintaining an annular gap around the one mandrel of the plurality of mandrels received therein;
wherein the shell, the first insert, and the second insert are configured such that each material portion extruded from the annular gap around each mandrel is coupled to the second material portion extruded from the second annular gap around the column upon extrusion from the die assembly.

5. The die assembly of claim 1, wherein the first plate of the first insert comprises a ring portion and at least one leg extending radially inward from an inner surface of the ring portion transverse to the axial direction, and wherein the ring portion and the at least one leg collectively defines the plurality of first openings.

6. The die assembly of claim 5, wherein the mandrel extends from the at least one leg.

7. The die assembly of claim 1, wherein the hollow-core preform further comprises a nested tube, wherein an outer surface of the nested tube contacts an inner surface of the inner tube, the die assembly further comprising:
a third insert, wherein the third insert is configured to be disposed between the first insert and the second insert when the die assembly is in the assembled state, the third insert comprising:
a third plate having a first surface and a second surface opposite the first surface, a plurality of third openings extending through the first plate from the first surface to the second surface along the axial direction; and
a sleeve extending from the second surface of the third plate along the axial direction, wherein the sleeve is configured to be received inside the channel of the second insert while an annular gap is maintained around the sleeve, and wherein the sleeve is further configured to receive the mandrel of the first insert while an annular gap is maintained between the sleeve and the mandrel received therein.

8. The die assembly of claim 7, wherein the sleeve further comprises a side opening.

9. The die assembly of claim 8, wherein the side opening is aligned with the slot of the second insert.

10. The die assembly of claim 7, wherein the third plate further comprises a ring portion and a leg extending radially inward from an inner surface of the ring portion transverse to the axial direction.

11. The die assembly of claim 10, wherein the sleeve extends from the leg of the third plate.

12. The die assembly of claim 1, wherein:
the shell comprises a first wall portion and a second wall portion arranged along an axial direction of the die assembly, wherein:
the first wall portion comprises an inner surface defining a first cavity portion that is cylindrical and has a first diameter;
the second wall portion comprises:
a first inner surface extending radially inward from the inner surface of the first wall portion;
a second inner surface that is tapered and defines a second cavity portion that has a frustum shape; and
a third inner surface defining a third cavity portion that is cylindrical and has a third diameter less than the first diameter of the first cavity portion of the first wall portion;
wherein the second inner surface is disposed between the first inner surface and the third inner surface;
the first plate of the first insert comprises:
a first surface and a second surface opposite the first surface, wherein:
the plurality of first openings extend through the first plate from the first surface to the second surface along the axial direction; and
the mandrel extends from the second surface of the first plate along the axial direction; and
the second plate of the second insert comprises:
a first surface and a second surface opposite the first surface, wherein:
the plurality of second openings extend through the second plate from the first surface to the second surface along the axial direction; and
the column extends from the second surface of the second plate along the axial direction; and
when the die assembly is in an assembled state:
the first insert and the second insert are received inside the shell;
the second insert is supported by the first inner surface of the second wall portion of the shell;
the first insert is supported by the first surface of the second plate of the second insert;
the second surface of the first plate of the first insert and the first surface of the second plate of the second insert are spaced apart along the axial direction by a plurality of spacers;
at least a portion of the column of the second insert is received in the third cavity portion of the second wall portion of the shell; and
a diameter of the column of the second insert is less than the third diameter of the third cavity portion such that a second annular gap is maintained between the column of the second insert and the second wall portion of the shell.

13. A die assembly for making a hollow-core preform or a component thereof via extrusion, wherein the hollow-core preform or the component thereof comprises an outer tube and a spiral panel, wherein an outer surface of the spiral panel contacts an inner surface of the outer tube, the die assembly comprising:
an insert comprising a plate having a plurality of openings forming portions of a tubular volume and a spiral member having a pair of spiral walls extending from the plate, wherein the pair of spiral walls and the plate collectively define a spiral channel extending through the plate and between the pair of spiral walls; and
a shell configured for receiving therein the insert;
wherein the insert and the shell are configured such that when the die assembly is in an assembled state and in use, material portions extruded through the plurality of openings become fluidly coupled to each other to form a continuous tubular body, and wherein a material portion extruded from the spiral channel is fluidly coupled to the continuous tubular body upon extrusion from the die assembly.

14. The die assembly of claim 13, wherein the spiral channel is in fluid communication with at least one of the plurality of openings of the insert.

15. The die assembly of claim 13, wherein the spiral member further comprises a slot formed in one of the pair of spiral walls, wherein the slot extends axially along a length of the one of the pair of spiral walls, and wherein the slot extends radially outward from the spiral channel.

16. A method of producing a hollow-core optical fiber preform and/or a component thereof, the method comprising:
providing a precursor material, wherein providing the precursor material comprises one of:
heating the precursor material such that a viscosity of the precursor material reaches about 10³ to about 10⁷ poise; or
forming a paste comprising a glass powder and a binder, wherein the precursor material comprises the paste;
extruding the precursor material through a die assembly to a shaped body;
forming a hollow-core preform or a component thereof from the shaped body, wherein the hollow-core preform comprises an outer tube and one of:
an inner tube, wherein an outer surface of the inner tube contacts an inner surface of the outer tube; or
a spiral panel, wherein an outer surface of the spiral panel contacts an inner surface of the outer tube;
wherein the die assembly comprises a die assembly of claim 1 or claim 13.

17. The method of claim 16, wherein heating the precursor material comprises:
heating a boule of glass, wherein the glass comprises at least one of pure silica, doped silica, fused silica, quartz, borosilicate glass, aluminoborosilicate glass, aluminosilicate glass, fluorosilicate glass, phosphosilicate glass, fluorophosphate glass, sulfophosphate glass, germanate glass, vanadate glass, borate glass, or phosphate glass; or
heating a polymer, wherein the polymer comprises at least one of acrylic, polyvinyl chloride (PVC), polyether ether ketone (PEEK), polyethylene, or polypropylene.

18. The method of claim 16, wherein:
the glass powder comprises at least one of pure silica powder, doped silica powder, fused silica powder, quartz powder, borosilicate glass powder, aluminoborosilicate glass powder, aluminosilicate glass powder, fluorosilicate glass powder, phosphosilicate glass powder, fluorophosphate glass powder, sulfophosphate glass powder, germanate glass powder, vanadate glass powder, borate glass powder, or phosphate glass powder; and/or
the binder comprises at least one of methyl cellulose, polyethylene, pine oil, or polyvinyl alcohol.

19. The method of claim 16, wherein forming a hollow-core preform or a component thereof from the shaped body comprises at least one of:
heat treating the shaped body to burn out the binder;
exposing the shaped body to a chlorine atmosphere to eliminate contaminates; or
heat treating the shaped body to sinter the glass powder.
